(19) United States
(12) Patent Application Publication
(10) Pub. No.: US 2013/0116817 A1
(43) Pub. Date: May 9, 2013

(54) SYSTEM AND METHOD FOR MACHINING AND INSPECTING A WORKPIECE

(71) Applicants: Paul R. Faughnan, JR., East Hampton, CT (US); Edward Marchitto, Canton, CT (US); Jesse R. Boyer, Manchester, CT (US)

(72) Inventors: Paul R. Faughnan, JR., East Hampton, CT (US); Edward Marchitto, Canton, CT (US); Jesse R. Boyer, Manchester, CT (US)

(73) Assignee: UNITED TECHNOLOGIES CORPORATION, Hartford, CT (US)

(21) Appl. No.: 13/289,500

(22) Filed: Nov. 4, 2011

(51) Int. Cl. G05B 19/401

(52) U.S. Cl. 700/173; 700/174

(57) ABSTRACT

A method for machining and inspecting a workpiece includes steps of: supporting the workpiece with a workpiece support; moving a machining tool relative to the workpiece with a tool positioning system, and machining a workpiece feature into the workpiece with the machining tool as a function of reference geometry data; moving a measuring device relative to the workpiece with a measuring device positioning system that is independent of the tool positioning system, and mapping a geometry of the workpiece feature with the measuring tool to provide workpiece geometry data indicative thereof; and processing the workpiece geometry data and the reference geometry data with a processor to compare the geometry of the workpiece feature to a reference geometry.

### BACKGROUND OF THE INVENTION

1. Technical Field

This disclosure relates generally to machining and inspecting a workpiece and, more particularly, to machining and inspecting a workpiece with independent positioning systems.

2. Background Information

A typical system for machining and inspecting a workpiece (e.g., a component of a gas turbine engine) includes a positioning system and a device mount (e.g., a chuck). During a machining operation, a machining tool (e.g., a milling bit) is secured to the device mount. The positioning system moves the machining tool relative to the workpiece such that the machining tool can machine a feature (e.g., a cut) into the workpiece. The machining tool is removed from the device mount upon completion of the machining operation. During a subsequent inspection operation, a contact probe is secured to the device mount. The positioning system moves the contact probe relative to the workpiece such that the contact probe can map a geometry of the machined feature. The mapped geometry can then be compared to a reference geometry to determine whether the workpiece complies with a workpiece design specification. Such an inspection operation, however, does not account for error in the calibration of the positioning system because both the machining tool and the contact probe are manipulated by the positioning system; i.e., positioning system calibration error that affects the machining operation in turn would also affect the inspection operation. The inspection operation therefore may approve a workpiece that does not satisfy the workpiece design specification.

### SUMMARY OF THE DISCLOSURE

According to one aspect of the invention, a system is provided for machining and inspecting a workpiece. The system includes a workpiece support, a tool positioning system, a machining tool, a measuring device positioning system, a measuring device, and a processor. The workpiece support is adapted to support the workpiece during the machining and the inspection thereof. The tool positioning system is connected to the machining tool. The tool positioning system is adapted to move the machining tool relative to the workpiece support such that the machining tool machines a workpiece feature into the workpiece as a function of reference geometry data. The measuring device positioning system is connected to the measuring device. The measuring device positioning system is adapted to move the measuring device relative to the workpiece support independent of the tool positioning system. The measuring device is adapted to map a geometry of the workpiece feature and to provide workpiece geometry data indicative thereof. The processor is adapted to process the workpiece geometry data and the reference geometry data to compare the geometry of the workpiece feature to a reference geometry.

According to another aspect of the invention, a method is provided for machining and inspecting a workpiece. The method includes steps of: (a) supporting the workpiece with a workpiece support; (b) moving a machining tool relative to the workpiece with a tool positioning system, and machining a workpiece feature into the workpiece with the machining tool as a function of reference geometry data; (c) moving a measuring device relative to the workpiece with a measuring device positioning system that is independent of the tool positioning system, and mapping a geometry of the workpiece feature with the measuring tool to provide workpiece geometry data indicative thereof; and (d) processing the workpiece geometry data and the reference geometry data with a processor to compare the geometry of the workpiece feature to a reference geometry.

The foregoing features and the operation of the invention will become more apparent in light of the following description and the accompanying drawings.

### BRIEF DESCRIPTION OF THE DRAWINGS

FIG. 1 is a partially exploded perspective illustration of a system for machining and inspecting a workpiece.

FIG. 2 is a perspective illustration of an inspection system.

FIG. 3 is a partially exploded perspective illustration of an alternative system for machining and inspecting a workpiece.

FIG. 4 is a flow diagram of a method for machining and inspecting a workpiece.

### DETAILED DESCRIPTION OF THE INVENTION

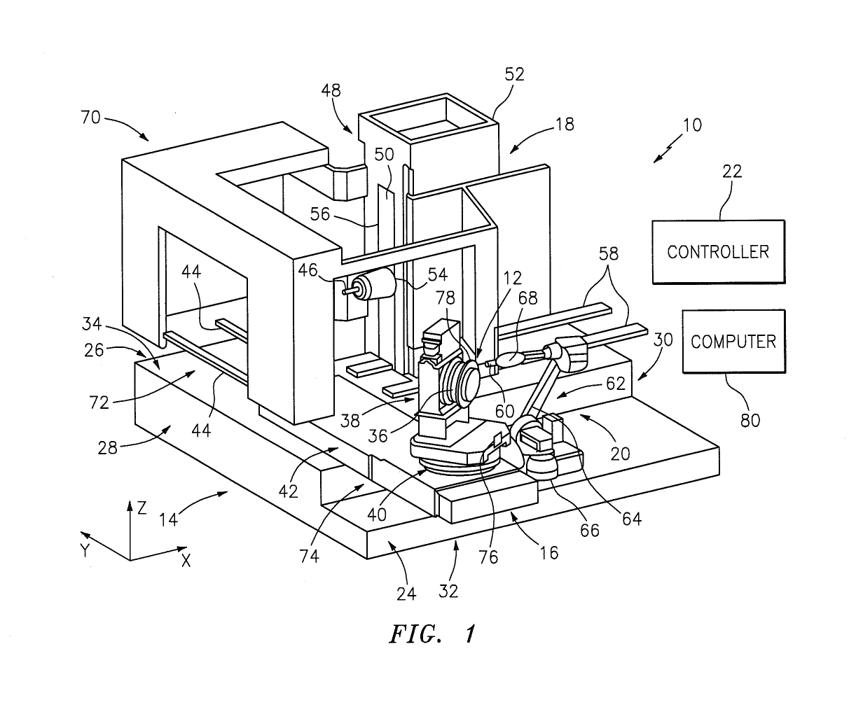

FIG. 1 is a partially exploded perspective illustration of a system 10 for machining and inspecting a workpiece 12. An example of a workpiece is a part for a gas turbine engine such as an integrally bladed rotor. The system 10 includes a base 14, a workpiece support 16, a machining system 18, an inspection system 20, and a controller 22.

The base 14 extends laterally (e.g., substantially parallel a y-axis) between a first side 24 and a second side 26. The base 14 extends longitudinally (e.g., substantially parallel an x-axis) between a third side 28 and a fourth side 30. The base 14 extends vertically (e.g., substantially parallel a z-axis) between a first end 32 and a second end 34.

The workpiece support 16 is adapted to move a workpiece mount 36 relative to one or more axes. In the embodiment illustrated in FIG. 1, for example, the workpiece support 16 includes a support stand 38, a support turntable 40 and a support base 42. The support stand 38 includes the workpiece mount 36, and is connected to the support base 42 by the support turntable 40. The support turntable 40 is adapted to rotate the workpiece mount 36 about a vertically extending axis (not shown). The support base 42 is adapted to laterally translate the workpiece mount 36 along one or more tracks 44.

The machining system 18 (e.g., a computer numerical control “CNC” machine) includes a machining tool 46 and a tool positioning system 48. The machining tool 46 can be configured as, for example, a drilling, boring, milling or grinding bit for a rotary tool, or a nozzle for a fluid and/or abrasive flow jet machine. The present invention, however, is not limited to any particular type of machining tool configuration.

The tool positioning system 48 is adapted to move the machining tool 46 relative to one or more axes. In the embodiment illustrated in FIG. 1, for example, the tool positioning system 48 includes a tool mount carriage 50 and a system base 52. The tool mount carriage 50 includes a tool mount 54 (e.g., a chuck) that connects the machining tool 46 thereto. The tool mount carriage 50 is adapted to vertically translate the machining tool 46 along a guide channel 56 in the system base 52. The system base 52 is adapted to longitudinally translate the machining tool 46 along one or more tracks 58.

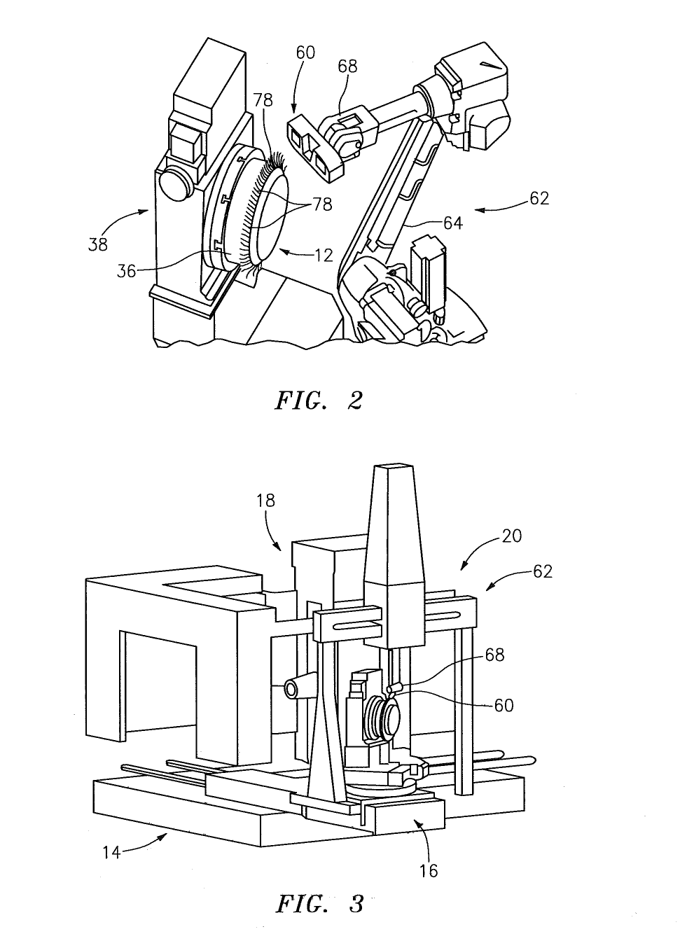

The inspection system 20 includes a measuring device 60 and a measuring device positioning system 62. In the embodiment illustrated in FIG. 1, the measuring device 60 is configured as a contact probe. In the embodiment illustrated in FIG. 2, the measuring device 60 is configured as a non-contact sensor such as a white light optical scanner or a laser line scanning system. An example of a white light optical scanner is disclosed in U.S. Patent Application Publication No. 2009/0033947, which is hereby incorporated by reference in its entirety.

Referring again to FIG. 1, the measuring device positioning system 62 is adapted to move the measuring device 60 relative to one or more axes, independent of the tool positioning system 48. In the embodiment illustrated in FIG. 1, for example, the measuring device positioning system 62 includes a robotic arm 64 that is connected to a turntable 66. The robotic arm 64 includes a measuring device mount 68 that connects the measuring device 60 thereto. The robotic arm 64 is adapted to translate the measuring device 60 vertically, horizontally and diagonally. The turntable 66 is adapted to rotate the measuring device 60 about a vertically extending axis (not shown). Alternatively, in the embodiment illustrated in FIG. 3, the measuring device positioning system 62 can be configured as a coordinate measuring machine adapted to longitudinally and vertically translate the measuring device 60.

Referring again to FIG. 1, in an assembled configuration, the support base 42 is positioned proximate the third side 28, and is slideably connected to the base 14 by the tracks 44. The system base 52 is positioned proximate the second side 26 between the workpiece support 16 and the fourth side 30. The system base 52 is slideably connected to the base 14 by the tracks 58. The turntable 66 is positioned proximate the first side 24 between the workpiece support 16 and the fourth side 30. The turntable 66 is connected to the base 14.

The controller 22 may be implemented using hardware, software, or a combination thereof. The hardware may include, for example, one or more processors, a memory, analog and/or digital circuitry, etc. The controller 22 is in signal communication (e.g., hardwired or wirelessly connected) with the workpiece support 16, the machining system 18 and the inspection system 20.

In some embodiments, the system 10 may further include a housing. In the embodiment illustrated in FIG. 1, for example, the machining system 18 is disposed within a machining system housing 70. The inspection system 20 is disposed outside the machining system housing 70. The workpiece support 16 is configured to move in and out of the machining system housing 70 between a machining position 72 and an inspection position 74. At the machining position 72, the workpiece support 16 is disposed within the machining system housing 70 adjacent the tool positioning system 48 (not shown). At the inspection position 74, the workpiece support 16 is disposed outside the machining system housing 70 adjacent the measuring device positioning system 62. Alternatively, the machining system 18, the inspection system 20 and/or the workpiece support 16 can each be disposed within a common system housing (not shown).

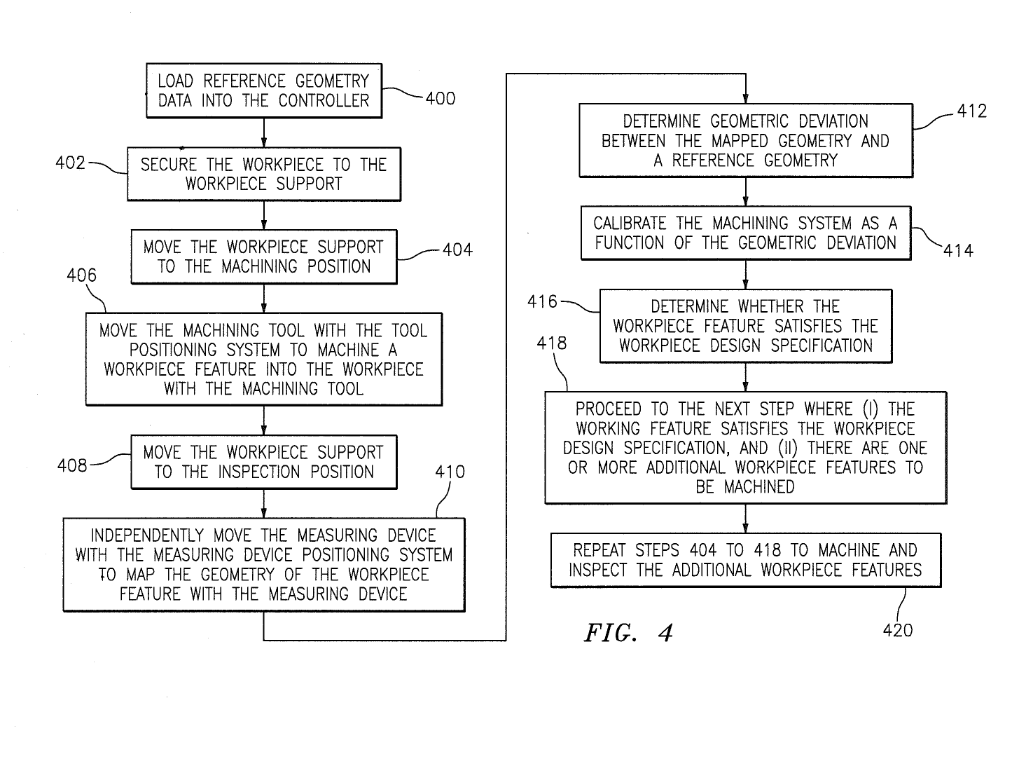

FIG. 4 illustrates a method for machining and inspecting the workpiece 12 with the system 10 illustrated in FIG. 1. Referring to FIGS. 1 and 4, in step 400, reference geometry data is loaded into the controller 22. The reference geometry data can include a plurality of reference coordinates that are indicative of a geometry of the workpiece 12 as it is designed and, more particularly, reference geometries of geometric features 78 of the workpiece 12 (hereinafter “workpiece features”) as they are designed. The term “reference coordinate” is used herein to describe a spatial location of a certain point on a surface of a workpiece feature relative to an origin 76 (e.g., a positioning artifact, a reference feature on the workpiece, etc.). An example of a workpiece feature is a cut, a protrusion, a fillet, an aperture, or a surface on the workpiece 12. The reference geometry can be indicative of, for example, a dimension (e.g., length, width, height) of the workpiece feature, a spatial orientation of the workpiece feature, a curvature of the workpiece feature, etc.

In step 402, the workpiece 12 is secured to the workpiece mount 36. In some embodiments, the workpiece 12 is secured such that there is a known spatial distance and orientation between the workpiece 12 and the origin 76 where, for example, the origin 76 is located on the workpiece support 16.

In step 404, the controller 22 signals the workpiece support 16 to move to the machining position 72 (not shown) where the workpiece 12 has a certain spatial position and orientation relative to the machining tool 46. In some embodiments, workpiece positional data indicative of the spatial position and orientation of the workpiece is preloaded into the controller 22. In other embodiments, the workpiece positional data is determined during operation. The workpiece positional data can be determined, for example, from (i) the spatial distance and orientation between the workpiece 12 and the origin 76, and (ii) a known (or determinable) spatial distance and orientation between the origin 76 and the machining tool 46.

In step 406, the controller 22 signals the machining system 18 to machine at least one workpiece feature 78 (e.g., see FIG. 2) into the workpiece 12 as a function of (i) the workpiece positional data, and (ii) the reference geometry data. The tool positioning system 48, for example, moves the machining tool 46 relative to the workpiece 12 such that the machining tool 46 machines one of the workpiece features (e.g., a cut), represented by the reference geometry data, into the workpiece 12.

In step 408, the controller 22 signals the workpiece support 16 to move to the inspection position 74.

In step 410, the controller 22 signals the inspection system 20 to map a geometry of each workpiece feature 78 machined during step 406, and to provide workpiece geometry data indicative thereof. The tetra “map” is used herein to describe a process for determining a measured coordinate for one or more points on a surface of the workpiece feature 78. The term “measured coordinate” is used herein to describe a spatial location of a certain point on a surface of a workpiece feature relative to an origin. The measured coordinates can be determined, for example, by moving the measuring device 60 with the measuring device positioning system 62 such that the measuring device 60 can determine the spatial location of each respective point on the surface of the workpiece feature 78 relative to the origin 76. The measured coordinates are subsequently output from the measuring device 60 as the workpiece geometry data.

In step 412, the controller 22 processes the workpiece geometry data and the reference geometry data to determine geometric deviations between the geometry of each workpiece feature 78 machined in step 406 and a respective one of the reference geometries. The controller 22, for example, can compare each measured coordinate to a corresponding one of the reference coordinates to determine geometric deviation therebetween. Alternatively, the controller 22 can (i) generate a geometric model of the workpiece feature 78 utilizing the measured coordinates, and (ii) compare the generated model to a reference model, included in or generated from the reference geometry data, to determine the geometric deviation therebetween.

In step 414, the controller 22 calibrates the machining system 18 as a function of the geometric deviations. The controller 22, for example, can adjust the workpiece positional data to correct for the geometric deviations between the measured coordinates and the corresponding reference coordinates. In this manner, the machining system 18 can reduce or eliminate future geometric deviation between the workpiece 12 being machined and the workpiece as it is designed.

In step 416, the controller 22 evaluates the geometric deviations to determine whether each workpiece feature 78 machined during step 406 satisfies a workpiece design specification. The workpiece design specification designates a set of geometric design parameters that workpiece features of the workpiece are designed to exhibit. A geometric tolerance for a relative spatial position of a certain point on the surface of the workpiece feature is an example of a geometric design parameter. The geometric deviations may satisfy the workpiece design specification where, for example, the geometric deviation between each of the measured coordinates and each corresponding reference coordinate is less than a respective geometric tolerance. The geometric deviations may not satisfy the workpiece design specification where, for example, one or more of the geometric deviations is greater than the respective geometric tolerances.

In step 418, the controller 22 determines whether to continue the present method as a function of the evaluation in step 416. The controller 22 may terminate the method where, for example, the workpiece feature 78 does not satisfy the workpiece design specification. The controller 22 may continue to the next method step where, for example, the workpiece feature 78 satisfies the workpiece design specification, and (ii) there are one or more additional workpiece features to be machined.

In step 420, the controller 22 repeats steps 404 to 418 to machine and subsequently inspect one or more additional workpiece features. In some embodiments, the additional workpiece features can be iteratively machined and inspected. In other embodiments, the additional workpiece features can be machined together, and subsequently inspected.

Referring again to FIG. 1, in some embodiments, the system 10 can further include a computer 80, external to the controller 22, that is in signal communication with the inspection system 20 and/or the controller 22. The computer 80 is adapted to process the workpiece geometry data and the reference geometry data such that, for example, the steps 412 and/or 416 can be performed at a later point in time (e.g., after the inspection system 20 and the controller 22 are powered down or off-line). The computer may be implemented using a combination of hardware and software. The hardware may include, for example, one or more processors, a memory, analog and/or digital circuitry, etc.

While various embodiments of the present invention have been disclosed, it will be apparent to those of ordinary skill in the art that many more embodiments and implementations are possible within the scope of the invention. Accordingly, the present invention is not to be restricted except in light of the attached claims and their equivalents.

What is claimed is:

1. A system for machining and inspecting a workpiece, comprising:
a workpiece support adapted to support the workpiece during the machining and the inspection thereof;
a tool positioning system connected to a machining tool, which tool positioning system is adapted to move the machining tool relative to the workpiece support such that the machining tool machines a workpiece feature into the workpiece as a function of reference geometry data;
a measuring device positioning system connected to a measuring device, which measuring device positioning system is adapted to move the measuring device relative to the workpiece support independent of the tool positioning system, and which measuring device is adapted to map a geometry of the workpiece feature and to provide workpiece geometry data indicative thereof; and
a processor adapted to process the workpiece geometry data and the reference geometry data to compare the geometry of the workpiece feature to a reference geometry.

2. The system of claim 1, wherein:
the tool positioning system and the machining tool are included in a machining system; and
the processor is further adapted to calibrate the machining system as a function of the comparison between the geometry of the workpiece feature and the reference geometry.

3. The system of claim 1, wherein the processor is further adapted to evaluate the comparison between the geometry of the workpiece feature and the reference geometry to determine whether the workpiece satisfies a workpiece design specification.

4. The system of claim 1, wherein:
the tool positioning system and the machining tool are included in a machining system that is adapted to machine the workpiece feature into the workpiece relative to an origin; and
the measuring device positioning system and the measuring device are included in an inspection system that is adapted to map the geometry of the workpiece feature relative to the origin.

5. The system of claim 1, wherein the workpiece support is adapted to move the workpiece laterally between a machining position and an inspection position, which machining position is adjacent the tool positioning system, and which inspection position is adjacent the measuring device positioning system.

6. The system of claim 1, wherein the workpiece support, the machining system and the inspection system are disposed within a common system housing.

7. The system of claim 1, wherein the measuring device comprises a contact probe.

8. The system of claim 1, wherein the measuring device comprises a non-contact sensor.

9. The system of claim 1, wherein the measuring device positioning system comprises one of a robotic arm and a coordinate measuring machine.

10. The system of claim 1, wherein the machining system comprises a computer numerical control machine.

11. A method for machining and inspecting a workpiece, comprising:
supporting the workpiece with a workpiece support;
moving a machining tool relative to the workpiece with a tool positioning system, and machining a workpiece feature into the workpiece with the machining tool as a function of reference geometry data;
moving a measuring device relative to the workpiece with a measuring device positioning system that is independent of the tool positioning system, and mapping a geometry of the workpiece feature with the measuring tool to provide workpiece geometry data indicative thereof; and
processing the workpiece geometry data and the reference geometry data with a processor to compare the geometry of the workpiece feature to a reference geometry.

12. The method of claim 11, further comprising calibrating a machining system as a function of the comparison between the geometry of the workpiece feature and the reference geometry, which machining system includes the machining tool and the tool positioning system.

13. The method of claim 12, wherein the calibrating of the machining system comprises adjusting workpiece positional data to correct for deviation between the geometry of the workpiece feature and the reference geometry, which workpiece positional data is indicative of a spatial position and orientation of the workpiece relative to the machining tool.

14. The method of claim 12, further comprising:
moving the machining tool relative to the workpiece with the tool positioning system, and machining one or more additional workpiece features into the workpiece with the machining tool as a function of the reference geometry data;
moving the measuring device relative to the workpiece with the measuring device positioning system, and mapping a geometry of each additional workpiece feature with the measuring tool to provide additional workpiece geometry data indicative thereof; and
processing the additional workpiece geometry data and the reference geometry data with the processor to compare the geometry of each additional workpiece feature to a respective reference geometry.

15. The method of claim 11, further comprising evaluating the comparison between the geometry of the workpiece feature and the reference geometry to determine whether the workpiece satisfies a workpiece design specification.

16. The method of claim 15, wherein the evaluating of the comparison comprises comparing deviation between the geometry of the workpiece feature and the reference geometry to one or more geometric design parameters included in the workpiece design specification.

17. The method of claim 15, further comprising, where the workpiece satisfies the workpiece design specification, moving the machining tool relative to the workpiece with the tool positioning system, and machining one or more additional workpiece features into the workpiece with the machining tool as a function of the reference geometry data.

18. The method of claim 11, wherein the workpiece feature is machined into the workpiece relative to an origin.

19. The method of claim 18, wherein the mapping of the geometry of the workpiece comprises determining a spatial location of one or more points on a surface of the workpiece feature relative to the origin.

20. The method of claim 19, further comprising designating the origin with a positioning artifact.
